(19) United States
(12) Patent Application Publication
(10) Pub. No.: US 2008/0272519 A1
(43) Pub. Date: Nov. 6, 2008

(54) Method for Producing a Microcircuit Card

(75) Inventor: Francois Launay, Epron (FR)

Correspondence Address: YOUNG & THOMPSON, 209 Madison Street, Suite 500, ALEXANDRIA, VA, 22314, US

(73) Assignee: Oberthur Technologies, Paris (FR)

(21) Appl. No.: 12/158,999

(22) PCT Filed: Dec. 22, 2006
(86) PCT No.: PCT/FR2006/002854

§ 371 Date: Jun. 24, 2008

(30) Foreign Application Priority Data
Dec. 26, 2005 (FR) 0513319

(51) Int. Cl. B29C 41/42

(52) U.S. Cl. 264/334

(57) ABSTRACT

The invention relates to a method for producing a microcircuit card, comprising the following steps: a step for positioning a microcircuit in an open-cavity mould, and a step for depositing a material in the open cavity of the mould, the material being sufficiently poorly viscous for coating at least indirectly at least part of the microcircuit.

The present invention relates to a microcircuit card production method and associated microcircuit cards.

The invention relates to microcircuit cards including microprocessor cards, memory cards such as a Secure Digital (SD) memory card for storing digital data, smartmedia cards and multimedia minicards.

Microcircuit cards essentially comprise a card body, which is generally made from a plastic material, and an electronic module.

That electronic module includes a microcircuit in the form of an integrated circuit and a printed circuit to which the integrated circuit is fixed and which defines external electrical contact lands. The electronic module is fixed in the body of the card so that the electrical contact lands are flush with one of the main faces of the card body.

The specifications of such microcircuit cards are those defined by the ISO standard 7816, for example. In this case the expression smart card is used. According to this standard, the thickness of the card is approximately 0.76 mm. In this case, the microcircuit is able to communicate with a smart card reader to the ISO standard 7816, for example using the “T=0” protocol.

The card can have any thickness, however.

The card is adapted to be positioned in the card reader so that the contact lands of the card come into electrical contact with the connector of the card reader.

In another embodiment, the microcircuit can include a flash memory, a fingerprint sensor, a screen, a solar sensor.

A very widely used assembly method consists in producing the plastic support by processes involving lamination or injecting thermoplastic materials followed by gluing the electronic module into a cavity in the plastic support provided for this purpose. This latter operation is known as “embedding”.

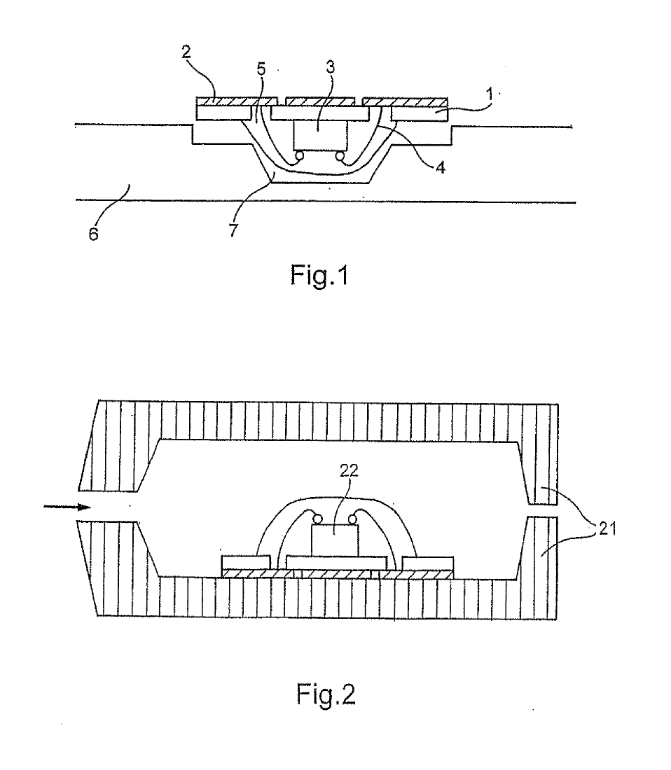

Thus FIG. 1 shows the embedding operation. The electronic module 1 has external electrical contacts 2 adapted to make a connection in the card reader and a microcircuit 3 comprising a microprocessor or a memory module, for example. The microcircuit 3 is connected to the external electrical contacts 2 by electrical connecting wires 4. In order to protect the electronic module, a resin 5 protects the microcircuit 3 and the electrical connecting wires 4. A plastic material card body 6 is fabricated and comprises a cavity 7 able to accommodate the electronic module 1. The electronic module 1 is then fixed into the cavity 7.

There is known from the document EP0277854 entitled “Memory card manufacturing process and cards obtained by this process” an injection molding method that eliminates this embedding step.

That method is based on the use of a mold 21 having the shape of the body of the required card, as shown in FIG. 2. It includes the insertion of an electronic module 22 into the mold 21 and holding the electronic module 22 in place so that the access face of the electronic module 22 is placed against a wall of the mold. A plastic material is then introduced into the mold so that the plastic material occupies the whole of the space delimited by the walls of the mold not occupied by the electronic module.

However, such systems have the drawback of being a complex production process. Likewise, holding the electronic module in position in the mold necessitates specific methods, notably based on pins or pistons, the consequence of which is to increase the cost of the molds.

Thus, when cards are fabricated by a molding process, there is always a requirement to reduce production costs and simplify the equipment.

To this end the invention proposes a microcircuit card production method comprising the following steps:
a step of positioning a microcircuit in an open cavity mold,
a step of depositing a material in the open cavity of the mold, the material being of sufficiently low viscosity to coat at least indirectly at least a portion of the microcircuit; and
a step of extracting the material with the microcircuit from the mold.

In effect, with the aim of simplifying the is microcircuit card production process and reducing the cost of the card, said microcircuit card is fabricated by depositing a material into an open mold.

The open mold is simpler to fabricate than an injection molding type mold and therefore of lower cost.

Moreover, this method does not necessitate any transfer press or injection mechanism.

The open cavity is notably in the shape of the microcircuit card to be fabricated.

The material used must be sufficiently liquid (of sufficiently low viscosity) for it to coat at least indirectly at least a portion of the microcircuit (where appropriate by means of a coating or similar resin) . The more liquid the material, the better the filling of the cavity of the mold (and, advantageously, the future mechanical bond between this material and the microcircuit) and the higher the possible industrial production throughput.

Moreover, this production method can necessitate the use of only low temperatures. Consequently, this method does not impact on the microcircuit of the card.

The invention can have various advantageous features, separately or in combination.

In one embodiment, the viscosity of the material produces a substantially smooth free surface after deposition.

According to this feature, the fact that the surface is smooth (and advantageously plane) has the effect of minimizing subsequent treatment of that surface.

Moreover, this material advantageously has a fluidity enabling it to be distributed in the mold, notably distributed homogeneously.

In one embodiment, the deposition is effected by casting in the mold.

The viscosity of the material is advantageously less than 10 000 mPa.s. However, it is preferable for the viscosity of the material to be from 500 to 5 000 mPa.s or from 50 to 100 mPa.s.

In one embodiment, the open cavity of the mold is advantageously the shape of the microcircuit card.

According to one advantageous feature, the material is a polymerizable material.

The material preferably primarily comprises a heat-set resin. It can further comprise a hardener.

Furthermore, the resin is polyurethane, for example.

In one embodiment, the material contains a charge, notably for adjusting the viscosity.

In particular embodiments, the method advantageously comprises a step of hardening the deposited material and/or a step of heating the deposited material and/or a step of preheating the mold.

In an industrial context involving high throughputs, this closely controls hardening of the smart card.

To impart the required stiffness to the fabricated microcircuit card, the method advantageously further comprises a polymerization step.

To this end, the resin is advantageously chosen to have, after the polymerization step, a glass transition temperature higher than 50° C.

In the context of mobile telephone microcircuit card production, the resin is advantageously chosen to have, after the polymerization step, a glass transition temperature higher than 70° C.

In one particular embodiment, the resin is advantageously chosen so that the hardness of the material is higher than 70 Shore D.

In a different embodiment, the step of depositing the material is advantageously carried out after the step of positioning the microcircuit.

The mold advantageously includes at least one hole formed in the bottom of the mold to hold the microcircuit in position by suction.

This feature simplifies the positioning of the microcircuit and retains it in the microcircuit card mold during the production phase.

The hole also facilitates extracting the microcircuit card from the mold after its production.

In one particular embodiment, the microcircuit advantageously has external contacts that are positioned against the bottom of the mold.

Said at least one hole is advantageously positioned at the location of the external contacts so that the retention of the external contacts is improved.

In a different embodiment, the step of depositing the material is carried out before the step of positioning the microcircuit.

In this embodiment, the microcircuit has external contacts that are positioned at the level of the surface of the deposited material before complete hardening.

In another embodiment, the microcircuit is advantageously fixed to a support film.

That support film advantageously carries external contacts.

The film advantageously has the external contacts on one face and the microcircuit on the other face, interconnections being established between terminals of the microcircuit and at least some of the external contacts.

The support film can equally further include at least part of an antenna, which antenna can advantageously be connected to the microcircuit.

In one embodiment, the antenna is advantageously on the face of the support film carrying the microcircuit.

The support film is advantageously fixed to the mold by at least one end and/or by drops of material. This feature ensures good retention of the support film in the mold during the phase of production of the microcircuit card in the mold.

In one particular embodiment, the microcircuit is fixed to the support film by a layer of adhesive on the support film. This feature holds the microcircuit in position on the film in the mold by means of the adhesive without needing any suction hole, for example.

According to one particular feature, the external contacts of the microcircuit are fixed to the support film by means of said adhesive layer.

According to another particular feature, the support film is removed to release the contacts of the microcircuit.

In another different embodiment of the invention, the microcircuit being fixed to a support film, there is advantageously a step of fixing the support film at an intermediate level in the mold so that the material coats the support film.

This feature fixes the support film so that the material coats the film, for example, and notably forms a card having the microcircuit at its core. That card can be a contactless card or a contact card in which the microcircuit is coated in the material.

The support film is advantageously provided with at least part of an antenna.

In one embodiment, the support film advantageously includes holes enabling the material to be spread.

In another embodiment, the support film is advantageously held at a distance from some sides of the mold.

In a further embodiment, the support film is advantageously retained by drops of material.

In another embodiment, the microcircuit is advantageously fixed to a support film, the method comprising the following steps:
a step of filling the bottom of the mold with a first deposit of material;
a step of positioning the support film in the material;
a step of covering the support film by filling in the mold with a second deposit of material.

This embodiment fabricates contactless microcircuit cards. This embodiment is nevertheless applicable to contact cards by fixing external contacts to the surface of the card and making electrical connections from those external contacts to the microcircuit.

In one particular embodiment, the support film is provided with at least part of an antenna.

The smart card can therefore be a contactless card or a dual card.

The card produced preferably conforms to the ISO standard 7816 with a thickness substantially equal to 0.76 mm.

The invention and the advantages that stem from it will become more clearly apparent on reading the description of embodiments given by way of nonlimiting example only, with reference to the appended drawings, in which:

FIG. 1 is a card fabricated by a prior art embedding method;

FIG. 2 is a prior art card fabricated by injection molding;

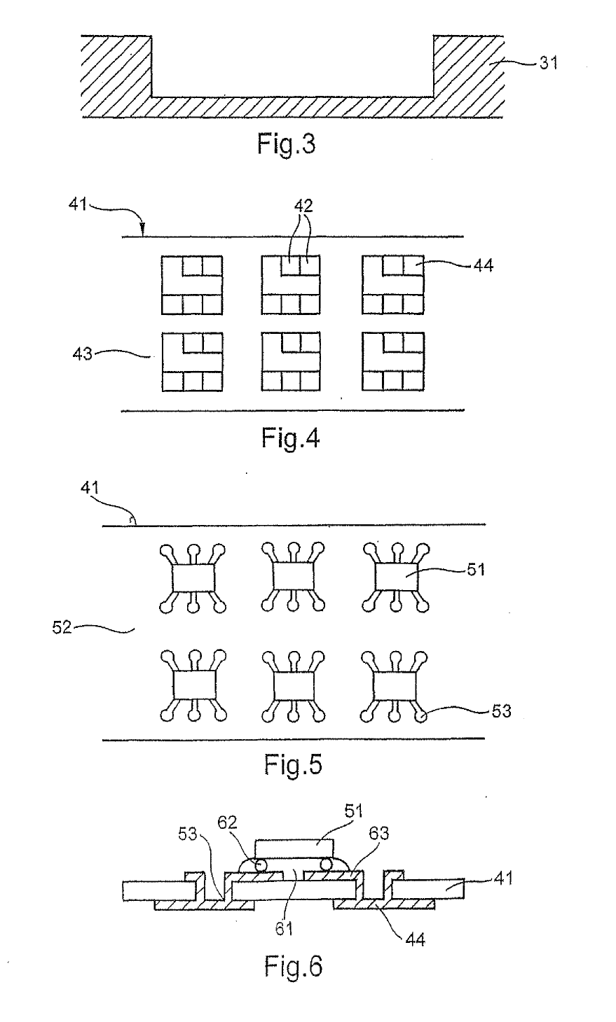

FIG. 3 is a diagrammatic representation of an open mold;

FIG. 4 is a diagrammatic representation of a support film having a set of patterns on the outside face;

FIG. 5 is a diagrammatic representation of the support film having microprocessors on the inside face;

FIG. 6 is a diagrammatic representation of a microcircuit fixed to a flip-chip support film;

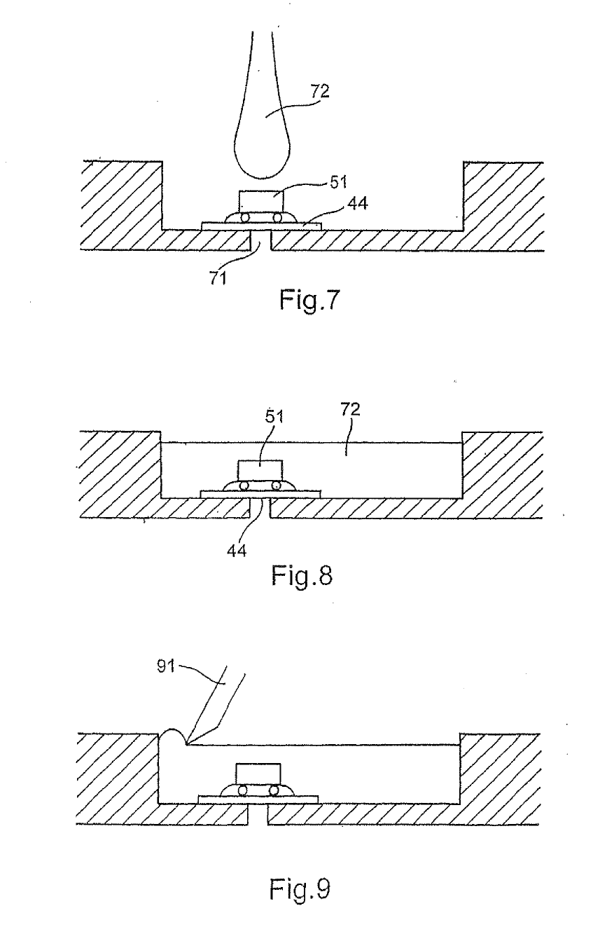

FIG. 7 illustrates the positioning of the microcircuit in the mold in accordance with the invention;

FIG. 8 shows the microcircuit card in a mold in accordance with the invention;

FIG. 9 shows the use of a squeegee in accordance with the invention;

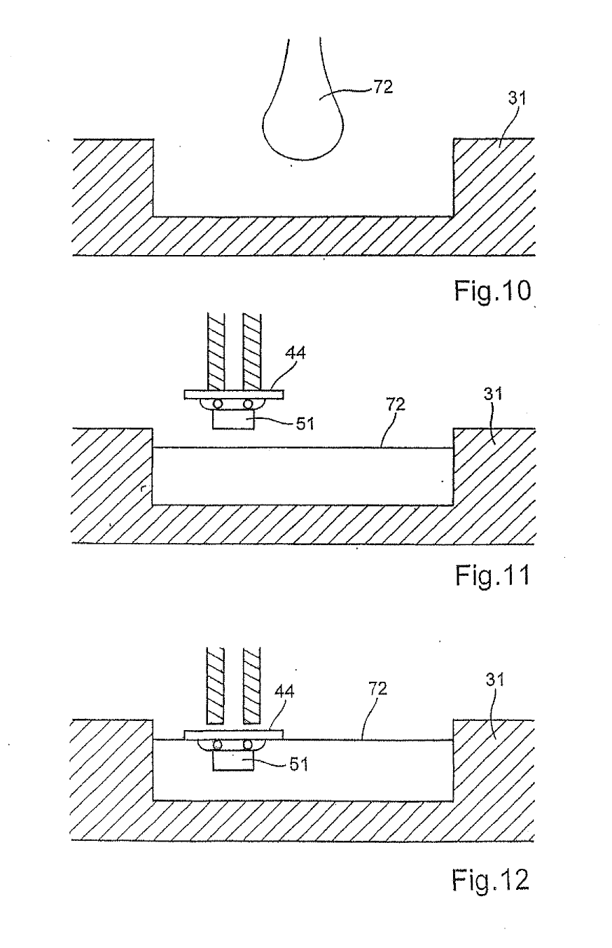

FIG. 10 illustrates the deposition of material in the mold before positioning the microcircuit;

FIG. 11 is a diagrammatic representation of the layer of material onto which the microcircuit will be placed;

FIG. 12 is a diagrammatic representation of a microcircuit fixed to the layer of material in the mold;

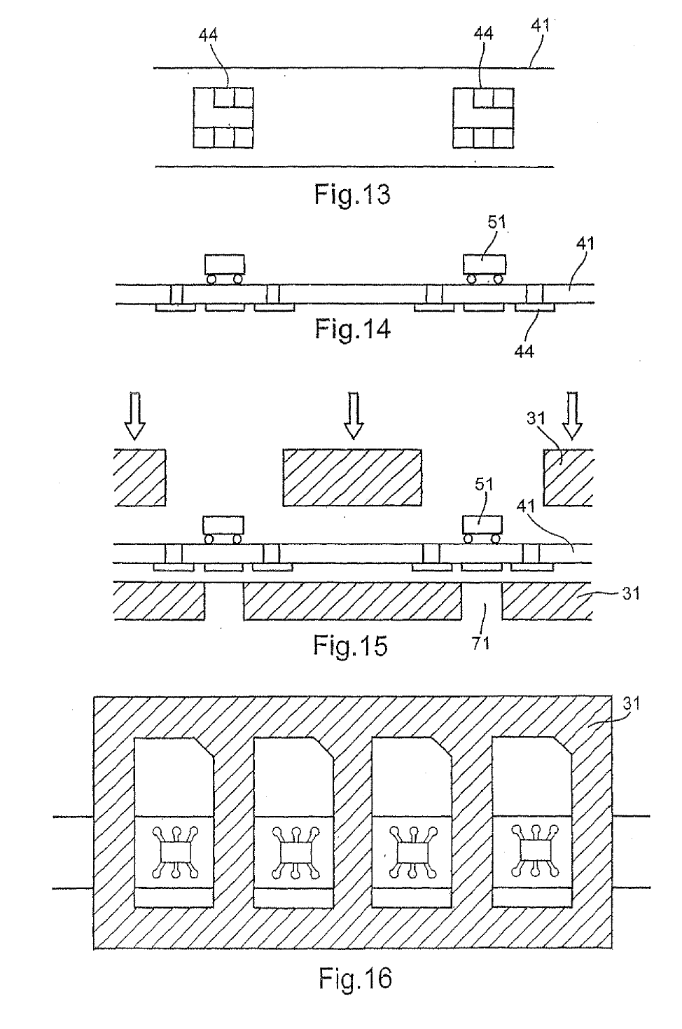

FIG. 13 shows a film having a single track of contacts;

FIG. 14 shows a film having a single track of contacts and microcircuits;

FIG. 15 shows a mold made up of removable elements;

FIG. 16 is a plan view of the molds;

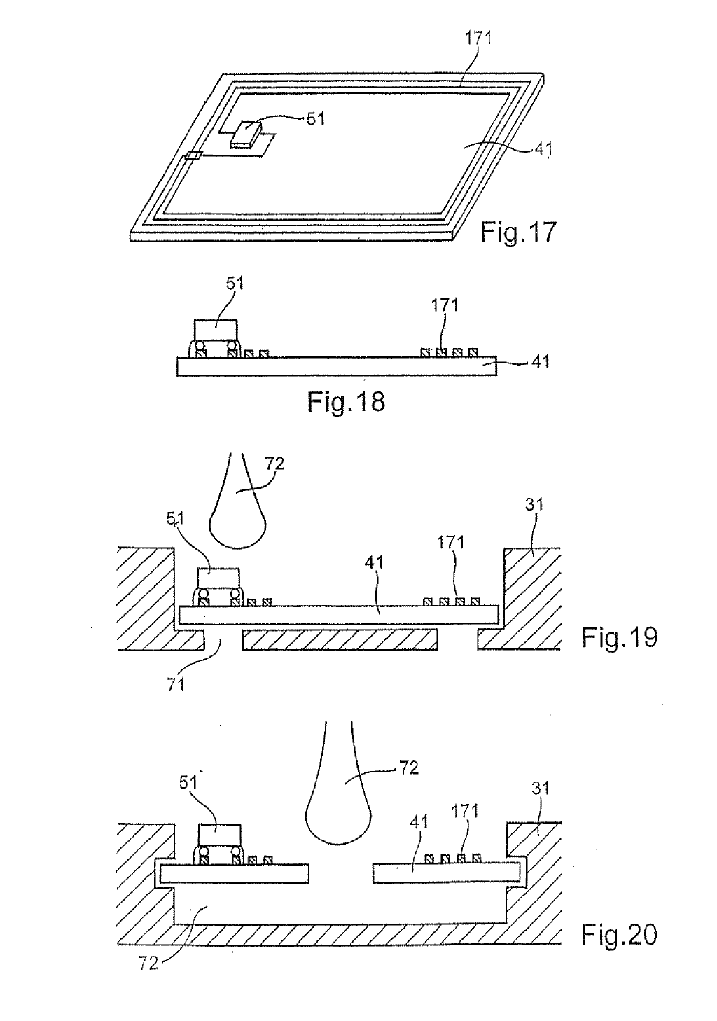

FIG. 17 shows a contactless card support;

FIG. 18 is a diagrammatic representation of a contactless card support;

FIG. 19 is a diagrammatic representation of a first embodiment of a contactless card in accordance with the invention;

FIG. 20 is a diagrammatic representation of a second embodiment of a contactless card in accordance with the invention;

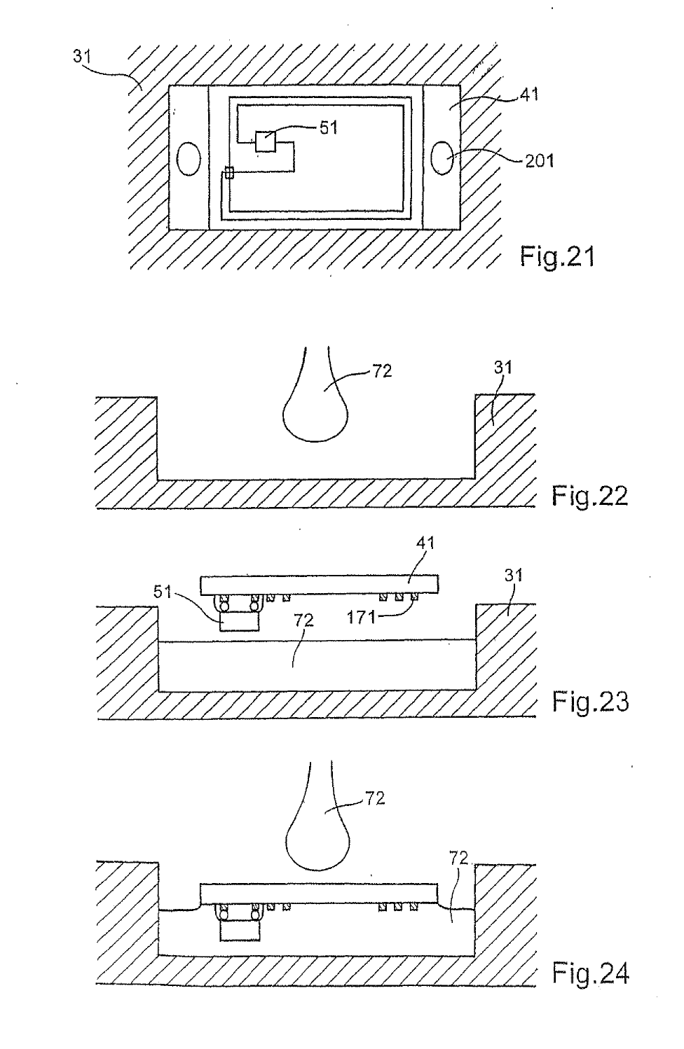

FIG. 21 is a variant of the second embodiment of a contactless card in accordance with the invention;

FIG. 22 illustrates deposition of material in the mold in order to fabricate a contactless card according to a third embodiment;

FIG. 23 illustrates the positioning of the inlay in the mold for fabricating a contactless card according to the third embodiment;

FIG. 24 illustrates the deposition of a second layer of material in the mold in order to fabricate a contactless card in accordance with the third embodiment; and

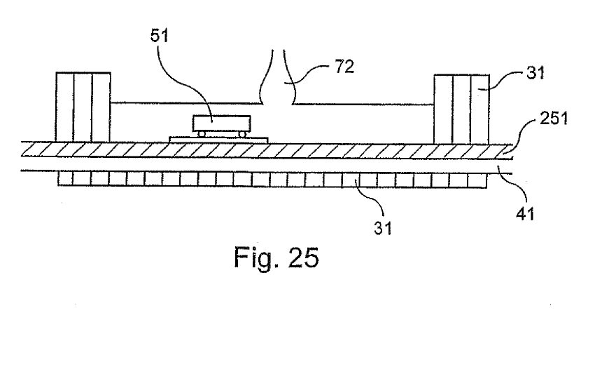

FIG. 25 is another embodiment of a mold made up of removable elements.

The invention consists in producing a card, notably a microcircuit card, by a low-cost molding process dispensing, also known as casting, a material, notably polyurethane resin, into an open mold.

To this end, the process uses an open mold 31 having an open cavity as shown in FIG. 3. The mold comprises an open cavity defining an imprint that gives the external shape of the body of the required card. To this end, it has the shape and the widthwise and lengthwise dimensions of the required card, thus reducing the production cost.

The mold can be the shape of a microcircuit card, i.e. can conform to the bank card format defined by the ISO standard 7316, but can equally be the shape of a minicard such as a SIM card conforming to the ISO standard 7816, for example, or an SD-Card.

Tn a different embodiment, the mold has the shape of an intermediate support used subsequently as a component part of the final microcircuit card. This intermediate support is, for example, a module consisting of a support comprising a microcircuit or a memory, or any other form.

In one embodiment, the microcircuit used includes one or more microprocessors and/or one or more memories as well as a support film that can carry internal and external contacts.

This support film can equally comprise a screen, an optical fingerprint sensor, or a micromechanical or micro-optical system.

In a different embodiment, the microcircuit can be present within the thickness of the support film or in a cavity in the support film provided for this purpose.

The thickness of the support film varies according to the materials used. On average it is from 50 μm to 200 μm.

FIGS. 4 and 5 show a support film on which the contacts and the microcircuits have been placed. The support film 41 is a flexible material, for example, comprising a plurality of patterns 42 serving as external contacts 44 for each microcircuit. These patterns are notably fixed to one face of the film 41 called the external face 43.

Microcircuits 51, comprising a microprocessor or a memory, for example, are fixed to the face opposite the external contact, i.e. the second face of the support film 41, also referred to as the internal face 52 of the 5 support film 41, as shown in FIG. 5. As a result, a microcircuit 51 is stuck to the internal face 52 of the support film at each location of an external contact 44 so that each external contact pattern includes a microcircuit.

In one particular embodiment, the external contacts 44 and the microcircuit 51 are not close together but far apart on the support film 41. The connection between the external contacts 44 and the microcircuit 51 is provided by conductive lines on or in the support film.

In another embodiment, the microcircuit 51 can be present within the thickness of the support film 41 or in a cavity in the support film provided for this purpose.

Electrical connections 53 are then made between the connecting terminals of the microcircuit 51 and at least one contact of a pattern of external contacts 44 carried by the external face 43 of the support film.

This yields a strip formed by the support film 41, which has on one of its faces a plurality of patterns, each pattern further including a microcircuit 51 that is associated with it on the opposite face of the film.

The support film can be an epoxy glass film, for example, a PET (polyethylene terephthalate) film, or a polyimide film.

In a different embodiment, the microcircuit 51 is not mounted on a support film but takes the form of a microcontroller and an antenna forming an integrated circuit.

The connection of the external contacts 44 and the microcircuit 51 through the support film 41 can be produced by a flip-chip method, as shown in FIG. 6.

Using this method, the external contacts 44 are on the external face 43 of the support film 41. On the internal face 52 of the support film 41 there is the microcircuit 51, which is connected to conductive tracks 53. The conductive tracks 63 connect the microcircuit 51 and the external contacts 44 to the electrical connection means 53, notably provided by plated through-holes also known as plated “vias”. The microcircuit 51 is fixed by insulative or anisotropic conductive glue 61, for example. Similarly, the connection between the microcircuit 51 and the conductive tracks 63 is made by a conductive increased thickness 62, also known as a “bump”.

In another embodiment in which the microchip is not mounted by the flip-chip method, the connection of the external contacts 44 and the microcircuit 51 through the support film 41 can be achieved by soldering wires between the microcircuit and the conductive tracks 63.

In one embodiment of the invention, each individual microcircuit is cut from the support film and positioned in the open mold. The external contacts of the microcircuit are positioned against the bottom of the mold, as shown in FIG. 7.

In the case of microcircuit cards, the position is defined by the ISO international standard, notably the ISO standard 7816.

The microcircuit can be retained during the molding operation by suction through a hole 71 formed in the bottom of the mold 31 at the required place, for example. This hold can also be used, subsequently, for extraction of the fabricated card from the mold.

In the case of using a support film comprising the microcircuit, the film is placed at the bottom of the mold and the suction hole holds the support film in position during the production phase.

In a further embodiment, the support film can be retained by depositing drops of material at the periphery of the support film.

A material 72 is then deposited, notably cast, in the mold containing the microcircuit so as to coat at least indirectly at least a portion of the microcircuit, which microcircuit can itself be coated at least in part with a resin. This coating contributes to good adhesion of the material to the microcircuit. This material is a polyurethane resin, for example. It can notably be the F31 resin from Axson. This material must also have suitable wetting properties so that the material comes into contact at least in part and at least indirectly with the microcircuit.

The quantity of material deposited in the mold, notably by casting it, is calculated so as to fill the mold to the thickness of the required microcircuit card. A card fabricated in conformance to the ISO standard 7816 has a thickness of approximately 0.76 mm.

Of course, the deposition can be effected at a given location or at a plurality of locations simultaneously, for example using a plurality of deposition nozzles. This has the advantage of fabricating a large number of microcircuit cards quickly.

The deposited material is obtained notably by mixing a base polyurethane resin and a hardener to polymerize the resin.

The viscosity of the mixture must enable filling of the surface of the mold defining the card in a satisfactory way, to obtain a homogeneous thickness over all of said surface and to obtain a free surface that is substantially smooth and advantageously plane, as shown in FIG. 8.

To this end, the material can equally contain a charge, for example of titanium dioxide, to adjust the viscosity.

To this end, the viscosity of the mixture at 25° C. must be less than 10 000 mPa.s. The viscosity is preferably of the order of a few thousand mPa.s at 25° C. and advantageously from 500 to 5 000 mPa.s.

In an advantageous embodiment, the resin is the F31 resin from Axson, for example, having a viscosity from 50 to 100 mPa.s and a glass transition temperature higher than 500.

Note that a low temperature is sufficient for the production of such microcircuit cards. As a result, the process represents very little stress on the film, the microprocessor or the memory, and the connections between the microcircuit and the external contacts, those connections being made by a lead bonding or flip-chip process.

In one embodiment, a squeegee 91 is used to homogenize the thickness of the microcircuit card, for example.

The mold can also be preheated to accelerate gelling and hardening of the deposited material and to optimize its distribution in the open mold. The preheating temperatures are low, notably of the order of 40° C., to prevent the material hardening before it has filled the mold.

Likewise, the material can be hardened by other techniques such as UV hardening.

These techniques for hardening the material aim to control and/or significantly accelerate the microcircuit card production process. In fact, in an industrial context where the cards are produced by depositing material in an open mold, this hardening step significantly increases microcircuit card production productivity.

In one particular embodiment, the material used has a glass transition temperature after polymerization higher than 50° C. and a hardness higher than 70 Shore D, in order to resist temperature variations in use and to be sufficiently rigid to be inserted without problem into a connector, for example a microcircuit card reader.

For minicards, notably mobile telephone SIM or USIM identification cards, the glass transition temperature is above 70° C. because of a possible rise in temperature in the telephone in use.

External heating means on the free surface of the card can also be used to accelerate hardening. Relatively low temperatures of the order of 25° C. to 100° C. can be used, for example.

The microcircuit card is then extracted from the mold.

In another embodiment of the invention, the microcircuit card production process starts with depositing, notably casting, the material in the mold, before placement of the microcircuit as shown in FIG. 10.

To this end, there is deposited a layer of material having a thickness conforming to the required microcircuit card, notably a thickness of 0.76 mm for a card conforming to the ISO standard 7816, as shown in FIG. 11.

The microcircuit 51 is then positioned on the surface of the deposited material, taking great care that the external contacts connected to the microcircuit remain at the surface of the material, as shown in FIG. 12.

Finally, the structure obtained in this way is polymerized. This makes the microcircuit card stiff.

In another embodiment of the invention, the smart cards can be produced on the support film comprising microcircuits without detaching them from the support film.

In a further embodiment of the invention, instead of using a dual track support film, i.e. one having in parallel two series of contact patterns, as shown in FIGS. 3 and 4, a support film is used comprising a single series of contact patterns, which film is referred to as a single-track film.

In one embodiment, the microcircuits positioned on the support film are spaced by a distance strictly greater than the width of a card, as shown in FIGS. 13 and 14.

In one particular embodiment, the mold is in two parts. A first part comprises a plane support on which the film rests and a second part comprises a removable part defining the lateral dimensions of the required microcircuit card.

After positioning the film on the plane support, the removable part of the mold is folded down onto the film as shown in FIG. 15.

The mold assembled in this way is ready for the operation of molding the microcircuit card.

The support film can equally be retained at the bottom of the mold, during the molding operation, for example, by suction via a hole 71 at the required location in the bottom of the mold 31.

Thus material is deposited in the mold. FIG. 16 is a plan view of the molds showing the batch of microcircuit cards to be produced, the molds containing the microcircuits 51.

The method described hereinabove applies equally to the production of a contactless microcircuit card containing a support film comprising an antenna, and notably at least one microcircuit.

The microcircuit can be a microprocessor or a memory connected directly to the antenna, for example, by a flip-chip production process or by a lead bonding process.

Alternatively, the microcircuit comprises a microprocessor or a memory pre-assembled in a module, the latter being connected to the antenna.

FIGS. 17 and 18 show a support film 41 to which is fixed a microprocessor or a memory that is connected directly by a flip-chip method to the antenna 171 in order to fabricate a contactless microcircuit card.

The assembly consisting of the support film, the antenna, and the microprocessor is known as an “inlay”.

This inlay can be used to fabricate the microcircuit card.

In a first embodiment of an antenna card shown in FIG. 19, the inlay is positioned on the bottom of the open mold and the material is deposited, for example cast, onto the face of the inlay containing the microprocessor or the memory and the antenna.

The positioning of the inlay and holding it in position on the bottom of the mold can be effected by suction means via holes 71 in the bottom of the mold, as shown in FIG. 19.

The deposition of material on the inlay consists in casting a quantity of this material to obtain the required thickness.

In a second embodiment of an antenna card shown in FIG. 20, the inlay is positioned at an intermediate level in the open mold so that the inlay is positioned inside the card structure. This intermediate level is approximately at the middle of the required thickness of the microcircuit card.

For this, it is necessary for the material to be able to coat both faces of the inlay.

To this end, the inlay can be held by grooves in the lateral walls of the mold.

For the material to be able to spread over the bottom of the mold, in a first embodiment, holes 201 can be formed in the inlay, as shown in FIG. 20, to allow the material to flow under the inlay.

In a different embodiment, the sides of the mold are not covered by the inlay, as shown in FIG. 21, to allow the material to flow under the inlay layer.

In a further embodiment, the inlay is held in position by depositing drops of material.

In a further embodiment, the inlay can be incorporated in the card by a two-stage production process.

Initially, a first layer of material is deposited, for example cast, onto the bottom of the mold, as shown in FIG. 22. The thickness of this first layer corresponds to approximately half the thickness of the required card.

The inlay is then placed on the layer of material when it is still liquid, as shown in FIG. 23.

Finally, a second layer is deposited, for example cast, on the inlay so that it is positioned within the material of the card, as shown in FIG. 24. The thickness of the second layer corresponds to approximately the thickness of the first layer.

In this embodiment, the inlay is positioned at the middle of the thickness of the microcircuit card in order to obtain a microcircuit card having a symmetrical structure.

The present invention is in no way limited to the embodiments described and shown, of course.

For example, FIG. 25 shows an embodiment in which the microcircuit is fixed to a support film 41 via a layer 251 of adhesive on the support film 41.

More particularly, the external contacts of the microcircuit are fixed to a support film 41 via the layer 251 of adhesive on the support film 41.

In this embodiment, the mold is in two parts. A first part comprises a plane support on which the support film 41 rests and a second part comprises a removable part defining the lateral dimensions of the required microcircuit card.

After positioning the film on the plane support, the removable part of the mold is folded down onto the film, as shown in FIG. 25.

In this embodiment, the adhesive layer holds the microcircuit in position on the film and therefore incidentally holds the microcircuit in the correct position in the mold after positioning the film.

Material is then deposited in the mold.

After production, the material with the microcircuit and the support film is extracted from the mold. The film is then removed, to free the contacts of the microcircuit.

1. Microcircuit card production method comprising the following steps;
a step of positioning a microcircuit in an open cavity mold,
a step of depositing a material in the open cavity of the mold, the material being of sufficiently low viscosity to coat at least indirectly at least a portion of the microcircuit; and
a step of extracting the material with the microcircuit from the mold.

2. Production method according to claim 1, wherein the viscosity of the material produces a substantially smooth free surface after deposition.

3. Production method according to claim 1, wherein deposition is effected by casting in the mold.

4. Production method according to claim 1, wherein the viscosity of the material is less than 10 000 mPa.s.

5. Production method according to claim 4, wherein the viscosity of the material is from 500 to 5 000 mPa.s.

6. Production method according to claim 4, wherein the viscosity of the material is from 50 to 100 mPa.s.

7. Production method according to claim 1, wherein the open cavity of the mold is the shape of the microcircuit card.

8. Production method according to claim 1, wherein the material is a polymerizable material.

9. Production method according to claim 1, wherein the material primarily comprises a heat-set resin.

10. Production method according to claim 9, wherein the material further comprises a hardener.

11. Production method according to claim 9, wherein the resin is polyurethane.

12. Production method according to claim 9, wherein the material contains a charge.

13. Production method according to claim 1, including a step of hardening the deposited material.

14. Production method according to claim 1, including a step of heating the deposited material.

15. Production method according to claim 1, including a step of preheating the mold.

16. Production method according to claim 1, further including a polymerization step.

17. Production method according to claim 16, wherein the resin is chosen to have, after the polymerization step, a glass transition temperature higher than 50° C.

18. Production method according to claim 17, wherein, for a mobile telephone microcircuit card, the resin is chosen to have, after the polymerization step, a glass transition temperature higher than 70° C.

19. Production method according to claim 17, wherein the resin is chosen so that material has a hardness higher than 70 Shore D.

20. Production method according to claim 1, wherein the step of depositing the material is carried out after the step of positioning the microcircuit.

21. Production method according to claim 20, wherein the mold has at least one hole in the bottom of the mold for holding the microcircuit in position by suction.

22. Production method according to claim 21, wherein the microcircuit has external contacts that are positioned against the bottom of the mold.

23. Production method according to claim 22, wherein said at least one hole is positioned at the positions of the external contacts.

24. Production method according to claim 1, wherein the step of depositing the material is carried out before the step of positioning the microcircuit.

25. Production method according to claim 24, wherein the microcircuit has external contacts that are positioned on the surface of the deposited material before complete hardening.

26. Production method according to claim 1, wherein the microcircuit is fixed to a support film.

27. Production method according to claim 26, wherein the support film carries external contacts.

28. Production method according to claim 27, wherein the film has on one face the external contacts and on the other face the microcircuit, interconnections being established between terminals of the microcircuit and at least some of the external contacts.

29. Production method according to claim 26, wherein the support film further includes at least part of an antenna.

30. Production method according to claim 29, wherein said antenna is connected to the microcircuit.

31. Production method according to claim 29, wherein the antenna is on the face of the support film carrying the microcircuit.

32. Production method according to claim 26, wherein the support film is fixed to the mold by at least one end.

33. Production method according to claim 26, wherein the support film is retained by drops of material.

34. Production method according to claim 26, wherein the microcircuit is fixed to the support film by a layer of adhesive on the support film.

35. Production method according to claim 34, wherein the external contacts of the microcircuit are fixed to the support film by said adhesive layer.

36. Production method according to claim 34, wherein the support film is removed to free the contacts of the microcircuit.

37. Production method according to claim 1, wherein the microcircuit being fixed to a support film, there is a step of fixing the support film in the mold at an intermediate level so that the material coats the support film.

38. Production method according to claim 37, wherein the support film is provided with at least part of an antenna.

39. Production method according to claim 37, wherein the support film includes holes enabling the material to spread.

40. Production method according to 37, wherein the support film is held at a distance from some sides of the mold.

41. Production method according to claim 37, wherein the support film is retained by drops of material.

42. Production method according to claim 1, wherein the microcircuit is fixed to a support film, the method comprising the following steps:
a step of filling the bottom of the mold with a first deposit of material;
a step of positioning the support film in the material;
a step of covering the support film by filling in the mold with a second deposit of material.

43. Production method according to claim 42, wherein the support film is provided with at least part of an antenna.

44. Production method according to claim 1, wherein the fabricated card conforms to the ISO standard 7816 with a thickness substantially equal to 0.76 mm.
